(19) United States
(12) Patent Application Publication
(10) Pub. No.: US 2008/0256876 A1
(43) Pub. Date: Oct. 23, 2008

(54) DOOR STRIPS

(76) Inventors: David Kenneth Hodges, Malvern (GB); Vincent Conroy, Axminster (GB)

Correspondence Address: KING & SCHICKLI, PLLC, 247 NORTH BROADWAY, LEXINGTON, KY, 40507, US

(21) Appl. No.: 12/104,656

(22) Filed: Apr. 17, 2008

Related U.S. Application Data
(60) Provisional application No. 60/912,255, filed on Apr. 17, 2007.

(30) Foreign Application Priority Data
Apr. 18, 2007 (GB) 0707401.6

(51) Int. Cl. E06B 3/30

(52) U.S. Cl. 49/501; 49/506

(57) ABSTRACT

According to the invention there is provided a strip for providing a finish to a longitudinal edge of a door, the edge having spaced apart side regions, each side region contacting a main face of the door, in which the strip includes a central groove for locating in a longitudinal groove formed in a longitudinal edge of the door, a pair of edge portions each for abutting against a side region when the central groove is located in the longitudinal groove, and a pair of connecting regions, each connecting the central groove to an edge portion, wherein the pair of connecting regions define upper surfaces of the strip, and the central groove and the pair of edge portions are positioned below the level of the upper surfaces.

This application claims the benefit of U.S. Provisional Patent Application Ser. No. 60/912,255, filed Apr. 17, 2007, and United Kingdom Application No. 0707401.6, filed Apr. 18, 2007, the disclosures of each of which are incorporated herein in their entirety by reference.

### FIELD OF THE INVENTION

This invention relates to doors strips for providing finishes to the edges of doors, with particular, but not exclusive, emphasis being placed on slab doors.

### BACKGROUND OF THE INVENTION

Slab doors are a well-known form of door which are generally provided in the form of a rectangular door without hinges or a frame. FIG. 1 shows a known form of a slab door, shown generally at 10, which comprises a foam core region 12, a timber lock reinforcement block 14 adjacent one end of the foam core region 12 and an extruded plastic edge region 16 which is adjacent the reinforcement block 14. The foam core region 12, timber lock reinforcement block 14 and edge region 16 are disposed between two spaced apart door skins 18, 20 which define the front and back surfaces of the door 10. The edge region 16 defines a longitudinal edge 16a of the slab door 10, and the door 10 has two such longitudinal edges. It can be seen in FIG. 1(b) that, underneath the longitudinal edge 16a and adjacent the ends of the door skins 18, 20 there are disposed longitudinal passages 22.

It is customary practice for manufacturers to provide slab doors in a range of standard widths, and to reduce the width of a standard slab door by removing material from one or both longitudinal edges in order to match a specific doorframe in which it is desired to fit the slab door. It would be desirable to utilise the slab door which has the standard width closest to the width of the doorframe in question when performing this process for a number of reasons. Firstly, it is most cost effective to utilise the smallest door possible. Secondly, the use of a door having a width that most closely matches the doorframe which it is to be used in conjunction with results in the smallest amount of waste material being trimmed from the slab door. Thirdly, it is desirable from the point of view of structural integrity to remove the minimum amount of material from the slab door. However, to date, it has proven difficult to do this in practice. It is customary practice to fit each longitudinal edge of the trim slab door with a capping 24 (FIG. 1(c)) which is shaped to fit around the raised central region of the longitudinal edge. Difficulties are encountered when it is desired to trim only a small amount of material from the edges of the slab door so that the newly formed edge of the door falls within or slightly above the region of the longitudinal passages 22. In these instances, the capping 24 cannot fit properly to the trimmed door slab 10 or is only weakly supported by the door. Unfortunately, in practice it is often found that, if the most closely matched door slab is to be used in conjunction with common doorframes, the trimming process would result in these kinds of undesirable cutting. As a result, it is very often not possible to use the most closely matched door slab, and instead a much wider door slab is used, resulting in quite drastic width reduction involving the removal of relatively deep sections of the slab door.

The present invention, in at least some of its embodiments, addresses the above described problems and desires. Although the invention is particularly advantageous when utilised in connection with slab doors, the invention is applicable also to other types of door.

### SUMMARY OF THE INVENTION

According to a first aspect of the invention there is provided a strip for providing a finish to a longitudinal edge of a door, the edge having spaced apart side regions, each side region contacting a main face of the door, in which the strip includes a central groove for locating in a longitudinal groove formed in a longitudinal edge of the door, a pair of edge portions each for abutting against a side region when the central groove is located in the longitudinal groove, and a pair of connecting regions, each connecting the central groove to an edge portion, wherein the pair of connecting regions define upper surfaces of the strip, and the central groove and the pair of edge portions are positioned below the level of the upper surfaces. It is understood that the term “upper”, when used in this context, refers to the regions of the strip which, in use, stand furthest proud from the longitudinal edge of the door in which it resides. In this way it is possible to use the most closely matched door for the particular application envisaged, and conveniently remove a minimal amount of material from the door prior to securely fitting the strip.

Strips of the invention can be fitted in instances in which it is desired to trim only a small amount of material from the edges of a slab door so that the newly formed edge of the door falls within or slightly above the region of the longitudinal passages. It is advantageous that strips of the invention can be produced having a significant height, enabling a significant amount of material to be trimmed from the door without affecting the overall width of the door once the strip is fitted. This enables a slab door to be trimmed below the level of the longitudinal passages with no reduction or only a small and controlled reduction in the overall width of the door.

Preferably, the strip is for providing a finish to a longitudinal edge of a slab door of the kind having an inner core disposed between two spaced apart door skins, in which the pair of edge portions are each for abutting against a door skin when the central groove is located in the longitudinal groove.

In preferred embodiments, the central groove extends further below the level of the upper surfaces than do the edge portions. However, it is possible for the central groove and the edge portions to extend to substantially the same level below the level of the upper surfaces, or for the edge portions to extend further below the level of the upper surfaces than does the central groove.

The connecting regions may each include an upper wall which defines the upper surface of the strip and a pair of side walls which are spaced apart by the upper wall.

Preferably, the edge portions are flats. The flats may extend substantially perpendicularly from a side wall of a connecting region.

Preferably, the strip further includes a trim strip for locating in the central groove. The trim strip can provide a pleasing and practical finished appearance. It is also possible to receive a hardware device or a hardware locating device in the central groove. For example, the strip may incorporate one or more cut outs for hinges, or the strip may incorporate an integral lock. Advantageously, the central groove includes one or more projections for facilitating the location of the trim strip in the central groove.

According to a second aspect of the invention there is provided a door having finishes on its longitudinal edges, in which:

the door has longitudinal grooves formed in its longitudinal edges; and

each longitudinal edge has a finish in the form of a strip, the strip including a central groove for locating in a longitudinal groove formed in the longitudinal edge of the door, a pair of edge portions each for abutting against a side region when the central groove is located in a longitudinal groove, and a pair of connecting regions, each connecting the central groove to an edge portion, wherein the pair of connecting regions define upper surfaces of the strip, and the central groove and the pair of edge portions are positioned below the level of the upper surfaces;

wherein the central groove of each strip is positioned in a corresponding longitudinal groove in a longitudinal edge of the door, and the edge portions of each strip abut against the corresponding side regions in said longitudinal edge.

Preferably, the door is a slab door of the kind having an inner core disposed between two spaced apart door skins, and the edge portions of each strip abut against the corresponding door skins in the longitudinal edge.

According to a third aspect of the invention there is provided a method of providing finishes to the longitudinal edges of a door, the edges having spaced apart side regions, each side region contacting a main face of the door, the method including the steps of:

providing a pair of strips, each strip including a central groove for locating in a longitudinal groove formed in a longitudinal edge of the door, a pair of edge portions each for abutting against the door skin when the central groove is located in the longitudinal groove, and a pair of connecting regions, each connecting the central groove to an edge portion, wherein the pair of connecting regions define upper surfaces of the strip, and the central groove and the pair of edge portions are positioned below the level of the upper surfaces;

reducing the width of the door to a desired width by removing material from both longitudinal edges;

forming a longitudinal groove in each longitudinal edge; and

for each longitudinal edge, positioning a strip in the longitudinal edge by locating the central groove of the strip in a corresponding longitudinal groove thereby causing the edge portions of the strip to abut against the corresponding side regions in the longitudinal edge.

Preferably, the door is a slab door of the kind having an inner core disposed between two spaced apart door skins, and the edge portions of each strip abut against the corresponding door skins in the longitudinal edge.

Advantageously, in respect of each longitudinal edge, removal of material from the longitudinal edge is performed simultaneously with the forming of a longitudinal groove therein. Very conveniently, the steps of reducing the width of the door and forming a longitudinal groove are performed by machining a desired profile into each longitudinal edge.

Whilst the invention has been described above, it extends to any inventive combination as set out or in the following description, drawings or claims.

### BRIEF DESCRIPTION OF THE DRAWING FIGURES

Embodiments of strips and doors in accordance with the invention will now be described with reference to the accompanying drawings, in which:—

FIG. 1 shows (a) a perspective view of a prior art slab door, (b) a cross-sectional view along the line A-A′ of (a), and (c) a prior art capping;

FIG. 2 shows (a) end views of a strip and trim of the invention and (b) a profile tool for use in conjunction with the strip of (a);

FIG. 3 shows cross-sectional views of one edge of a trim slab door having a strip located therein at (a) maximum slab door width and (b) minimum slab door width; and

FIG. 4 shows (a) an end view of a second embodiment of a strip of the invention and (b) a profile tool for use in conjunction with the strip of (a).

### DETAILED DESCRIPTION OF THE INVENTION

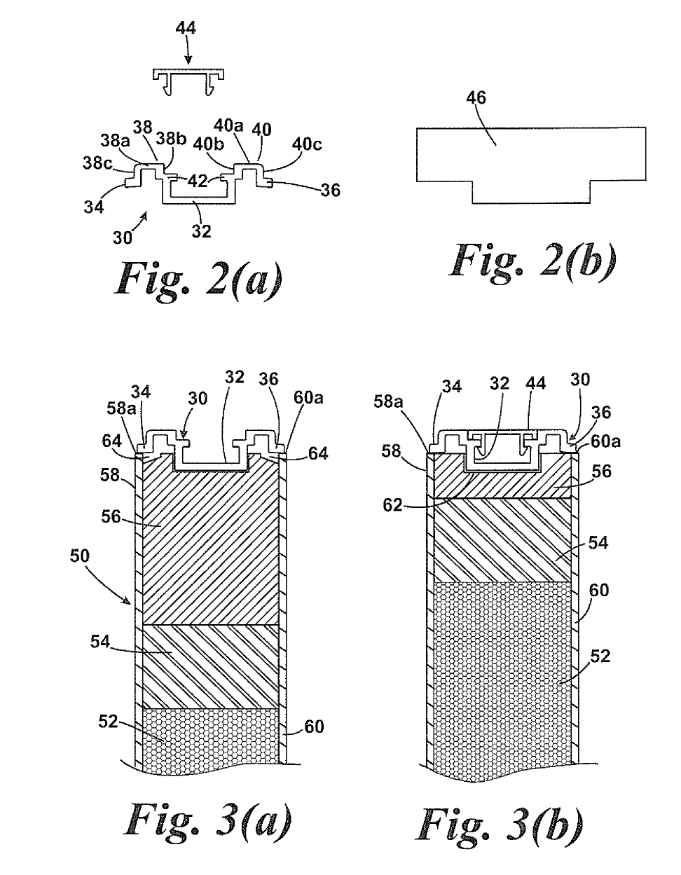

FIG. 2(a) shows a first embodiment of a strip 30 of the invention which comprises a central groove 32 and a pair of edge portions 34, 36. The strip 30 further comprises a pair of connecting regions 38, 40 which each connect the central groove 32 to an edge portion 34, 36. The central groove 32 has projections 42 enabling a trim 44 to be conveniently located and retained in the central groove 32. The central groove 32 can be of a standard design, such as a Euro groove, although the skilled reader will appreciate that many possible designs are possible. The connecting regions 38, 40 are substantially U shaped, and include an upper wall 38a, 40a which defines an upper surface of the strip 30 and a pair of side walls 38b, 38c, 40b, 40c which are spaced apart by the corresponding upper wall 38a, 40a. In respect of each connecting region 38, 40, one side wall 38b, 40b is connected to the central groove 32, and one side wall 38c, 40c is connected to an edge portion 34, 36. Conveniently, the edge portions 34, 36 are in the form of flats which are suitably sized and spaced so as to abut against the door skins of a slab door when the strip 30 is in use.

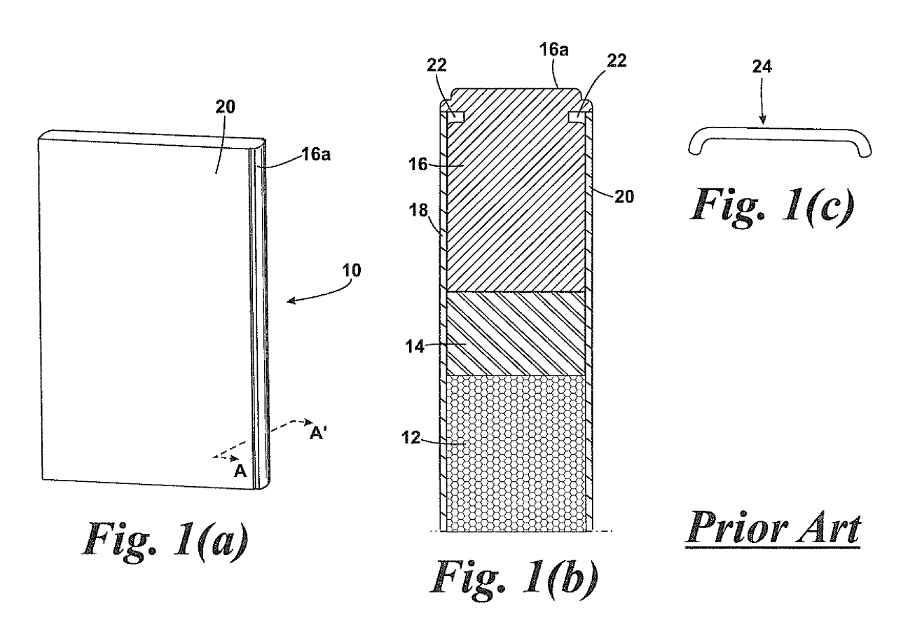

A slab door of the type shown in FIG. 1 is prepared for fitting of the strip 30 by way of reducing the width of the slab door using a profile tool 46 shown in FIG. 2(c). The profile tool 46 is used to remove material from each longitudinal edge of the slab door to a desired depth and form a longitudinal groove in the longitudinal edges of the slab edges in order to accommodate the central groove 32 of the strip 30. FIG. 3 shows one longitudinal edge of a slab door 50 which has been treated in this manner. It is understood that the other longitudinal edge of the slab door 50 would also have material removed therefrom thereby reducing the width of the door to a desired width. The door 50 comprises a foam core region 52, a timber lock reinforcement block 54, and an edge region 56 all of which are bounded on either side by door skins 58, 60. The machining of the longitudinal edges of the door 50 with the profile tool 46 results in the formation of a longitudinal groove 62 in each longitudinal edge of the door 50. FIG. 3(a) shows the instance in which a minimum amount of the material is removed from the longitudinal edges, resulting in the provision of a slab door having a strip located therein of maximum width. It should be noted that the profiling of the door is deep enough so that the exposed longitudinal edge of the door 50 resulting after the profiling comprises edges 58a, 60a of the door skins 58, 60. The strip 30 is located in the longitudinal edge of the slab door 50 by locating the central groove 32 of the strip 30 in the longitudinal groove 62 of the door slab 50, which also causes the flats 34, 36 to abut against the edges 58a, 60a of the door skins 58, 60. It will be appreciated that in this way a well fitting and aesthetically pleasing capping is provided even though the profiling performed includes sectioning of the longitudinal passages 64 present in the uncut door slab. It is advantageous if the strip is constructed so that in the instance shown in FIG. 3(a), i.e., when the minimum amount of material is removed from the longitudinal edges, the fitting of the strip 30 in the longitudinal edges results in no change in the overall width of the door. In other words, the strip 30 is constructed to stand proud of the edges 58a, 60a of the door skins 58, 60 by a height which equals the depth of material removed in the earlier profiling process.

FIG. 3(a) shows the instance in which a maximum amount of material is removed from the longitudinal edge during the profiling process, thereby resulting in a door slab having strips in place which is of minimum possible width. Removal of further material would result in door which is not structurally sound. Both of the embodiments shown in FIGS. 3(a) and (b) are possible, as indeed are embodiments having intermediate widths. However, it is particularly advantageous that the present invention can be used to produce finished slab doors of maximum width or nearly of maximum width, because this enables the standard door size which most closely matches the door frame in which the door is intended to reside to be utilised. Typically the strip 30 is fixed to the slab door 50 by way of fastening elements such as screws. Suitable apertures may be provided in the strip 30 to accommodate such fastening elements. It is in principle possible to arrange for the central groove 32 of the strip 30 to locate in the longitudinal groove 62 of the slab door 50 so as to retain the strip 30 in place. FIG. 3(b) shows a trim 44 positioned in the central groove 32 of the strip 30. The strip 30 may instead or additionally be used to accommodate a hardware locating device.

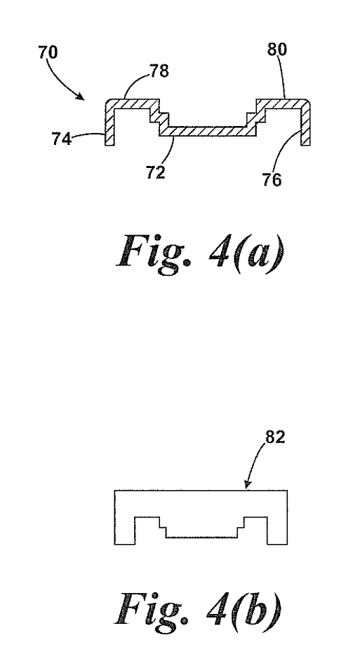

FIG. 4(a) shows a second embodiment of a strip 70 of the invention. The strip 70 comprises a stepped central groove 72, edge portions 74, 76 in the form of the side walls, and a pair of connecting regions 78, 80 which each connect the central groove 72 to an edge portion 74, 76. It can be seen that the edge portions 74, 76 extend more deeply than the central groove 72. FIG. 4(b) shows an associated profile tool 82 which would be used to trim the longitudinal edges of a slab door 50 prior to fitting of the strip 70 thereto.

The strips of the invention can be made from any convenient material, which may be a metal such as aluminium, a plastics material such as PVC, or pultruded GRP. Trims used in conjunction with strips of the invention can be conveniently manufactured from a suitable plastic material, such as PVC.

1. A strip for providing a finish to a longitudinal edge of a door, the edge having spaced apart side regions, each side region contacting a main face of the door, in which the strip includes a central groove for locating in a longitudinal groove formed in a longitudinal edge of the door, a pair of edge portions each for abutting against a side region when the central groove is located in the longitudinal groove, and a pair of connecting regions, each connecting the central groove to an edge portion, wherein the pair of connecting regions define upper surfaces of the strip, and the central groove and the pair of edge portions are positioned below the level of the upper surfaces.

2. A strip according to claim 1 for providing a finish to a longitudinal edge of a slab door of the kind having an inner core disposed between two spaced apart door skins, in which the pair of edge portions are each for abutting against a door skin when the central groove is located in the longitudinal groove.

3. A strip according to claim 1 in which the central groove extends further below the level of the upper surfaces than do the edge portions.

4. A strip according to claim 1 in which the connecting regions each include an upper wall which defines an upper surface and a pair of side walls which are spaced apart by the upper wall.

5. A strip according to claim 1 in which the edge portions are flats.

6. A strip according to claim 5 in which the connecting regions each include an upper wall which defines an upper surface and a pair of side walls which are spaced apart by the upper wall, and in which the edge portions each extend substantially perpendicularly from a side wall of a connecting region.

7. A strip according to claim 1 further including a trim strip for locating in the central groove.

8. A strip according to claim 7 in which the central groove includes one or more projections for facilitating the location of the trim strip therein.

9. A door having finishes on its longitudinal edges, in which:
the door has longitudinal grooves formed in its longitudinal edges; and
each longitudinal edge has a finish in the form of a strip, the strip including a central groove for locating in a longitudinal groove formed in the longitudinal edge of the door, a pair of edge portions each for abutting against a side region when the central groove is located in a longitudinal groove, and a pair of connecting regions, each connecting the central groove to an edge portion, wherein the pair of connecting regions define upper surfaces of the strip, and the central groove and the pair of edge portions are positioned below the level of the upper surfaces;
wherein the central groove of each strip is positioned in a corresponding longitudinal groove in a longitudinal edge of the door, and the edge portions of each strip abut against the corresponding side regions in said longitudinal edge.

10. A door according to claim 9 in which the door is a slab door of the kind having an inner core disposed between two spaced apart door skins, and the edge portions of each strip abut against the corresponding door skins in the longitudinal edge.

11. A method of providing finishes to the longitudinal edges of a door, the edges having spaced apart side regions, each side region contacting a main face of the door, the method including the steps of:
providing a pair of strips, each strip including a central groove for locating in a longitudinal groove formed in a longitudinal edge of the door, a pair of edge portions each for abutting against the door skin when the central groove is located in the longitudinal groove, and a pair of connecting regions, each connecting the central groove to an edge portion, wherein the pair of connecting regions define upper surfaces of the strip, and the central groove and the pair of edge portions are positioned below the level of the upper surfaces;
reducing the width of the door to a desired width by removing material from both longitudinal edges;
forming a longitudinal groove in each longitudinal edge; and
for each longitudinal edge, positioning a strip in the longitudinal edge by locating the central groove of the strip in a corresponding longitudinal groove thereby causing the edge portions of the strip to abut against the corresponding side regions in the longitudinal edge.

12. A method according to claim 11 in which the door is a slab door of the kind having an inner core disposed between two spaced apart door skins, and the edge portions of each strip abut against the corresponding door skins in the longitudinal edge.

13. A method according to claim 11 in which, in respect of each longitudinal edge, removal of material from the longitudinal edge is performed simultaneously with the forming of a longitudinal groove therein.

14. A method according to claim 13 in which the steps of reducing the width of the door and forming a longitudinal groove are performed by machining a desired profile into each longitudinal edge.
